(19) United States
(12) Patent Application Publication
(10) Pub. No.: US 2026/0260320 A1
(43) Pub. Date: Sep. 3, 2026

(54) IMAGE NOISE REDUCTION METHOD

(71) Applicant: TASMIT, Inc., Kanagawa (JP)

(72) Inventor: Taihei MORI, Kanagawa (JP)

(21) Appl. No.: 18/865,454

(22) PCT Filed: Apr. 26, 2023
(86) PCT No.: PCT/JP2023/016445

§ 371 Date: Nov. 13, 2024

(30) Foreign Application Priority Data
May 18, 2022 (JP) 2022-081548

(51) Int. Cl. G06T 5/70; G06T 5/60; G06T 5/73

(52) U.S. Cl. CPC G06T 5/70; G06T 5/60; G06T 5/73; G06T 2207/10061; G06T 2207/20024

(57) ABSTRACT

The present invention relates to an image noise reduction method for reducing noise on an image generated by a scanning electron microscope. The image noise reduction method includes: generating a reference image of a sample by the scanning electron microscope; generating an artificial-noise image by adding artificial noise to the reference image; generating an artificial low-quality image by applying an anisotropic filter to the artificial-noise image, the anisotropic filter being configured to stretch the artificial noise in a scanning direction of an electron beam of the scanning electron microscope; creating a denoising model by performing machine learning using training data including the reference image and the artificial low-quality image; generating an image of a workpiece by the scanning electron microscope, the workpiece being an object of inspection and shape measurement of a semiconductor device; inputting the image of the workpiece into the denoising model; and outputting a denoise image from the denoising model.

### TECHNICAL FIELD

The present invention relates to an image noise reduction method for reducing noise on an image generated by a scanning electron microscope.

### BACKGROUND ART

An image generated by a scanning electron microscope may contain noise due to various factors, such as optical factor or electrical factor. One solution for reducing such noise in the image is to use a denoising model. More specifically, an image containing noise is input to the denoising model, and a denoise image with reduced noise is output from the denoising model. Such denoising model is a trained model created by machine learning.

FIG. 4 is a schematic diagram showing an example of a conventional method for creating a denoising model by machine learning. The machine learning is performed using training data including a large number of sets of high-quality images and low-quality images generated by scanning electron microscope. A high-quality image and a low-quality image in each set are images of the same location on a sample, such as a wafer. The high-quality image is generated under low scan-rate conditions, and the low-quality image is generated under high scan-rate conditions.

However, this method requires generating images of the same location on the sample under different conditions (i.e., different scanning rates), which is very time consuming for the scanning electron microscope.

FIG. 5 is a schematic diagram showing another example of a conventional method for creating a denoising model by machine learning. The machine learning is performed using training data including a large number of sets of high-quality images generated by a scanning electron microscope and artificial-noise images. The high-quality images are generated under low scan-rate conditions, as well as the method shown in FIG. 4. The artificial-noise images are generated by adding artificial noise (e.g., Gaussian noise) to the high-quality images obtained. According to this method, the scanning electron microscope can generate images under the same conditions (the same scanning rate).

However, artificial noise, such as Gaussian noise, does not resemble real noise in images generated by a scanning electron microscope. As a result, the denoising model created by the machine learning may not be able to sufficiently reduce the noise.

### CITATION LIST

### Patent Literature

Patent document 1: Japanese laid-open patent publication No. 2021-197144

### SUMMARY OF INVENTION

### Technical Problem

Therefore, the present invention provides an image noise reduction method capable of accurately reducing noise from an image generated by a scanning electron microscope.

### Solution to Problem

In an embodiment, there is provided an image noise reduction method of reducing noise from an image generated by a scanning electron microscope, comprising: generating a reference image of a sample by the scanning electron microscope; generating an artificial-noise image by adding artificial noise to the reference image; generating an artificial low-quality image by applying an anisotropic filter to the artificial-noise image, the anisotropic filter being configured to stretch the artificial noise in a scanning direction of an electron beam of the scanning electron microscope; creating a denoising model by performing machine learning using training data including the reference image and the artificial low-quality image; generating an image of a workpiece by the scanning electron microscope, the workpiece being an object of inspection and shape measurement of a semiconductor device; inputting the image of the workpiece into the denoising model; and outputting a denoise image from the denoising model.

In an embodiment, the anisotropic filter has parameters including at least a scanning rate and a scanning direction of the electron beam and a response characteristic of an electron detector of the scanning electron microscope, and the parameters are set to coincide with parameters that are used when the image of the workpiece is generated.

In an embodiment, the anisotropic filter has parameters including at least material and cross-sectional structure of a surface of the sample, and acceleration voltage and current of the electron beam, and the parameters are set to coincide with parameters that are used when the image of the workpiece is generated.

In an embodiment, the artificial noise follows a statistical distribution.

In an embodiment, the artificial noise is Poisson noise.

In an embodiment, the artificial noise follows a normal distribution or a lognormal distribution.

### Advantageous Effects of Invention

According to the present invention, the anisotropic filter is configured to imitate noise that is characteristic of the scanning electron microscope. The anisotropic filter is applied to the artificial-noise image, so that the artificial low-quality image similar to an image containing real noise can be created. The machine learning is performed using training data including such artificial low-quality images and reference images (high-quality images) to thereby generate the denoising model that can accurately reduce noise.

### BRIEF DESCRIPTION OF DRAWINGS

FIG. 1 is a schematic diagram showing an embodiment of an image generation system;

FIG. 2 is a diagram explaining an embodiment of a method of creating a denoising model by machine learning;

FIG. 3 is a diagram showing examples of a reference image, an artificial-noise image, and an artificial low-quality image;

FIG. 4 is a diagram explaining an example of a conventional method of creating a denoising model by machine learning; and

FIG. 5 is a diagram explaining another example of a conventional method of creating a denoising model by machine learning.

### DESCRIPTION OF EMBODIMENTS

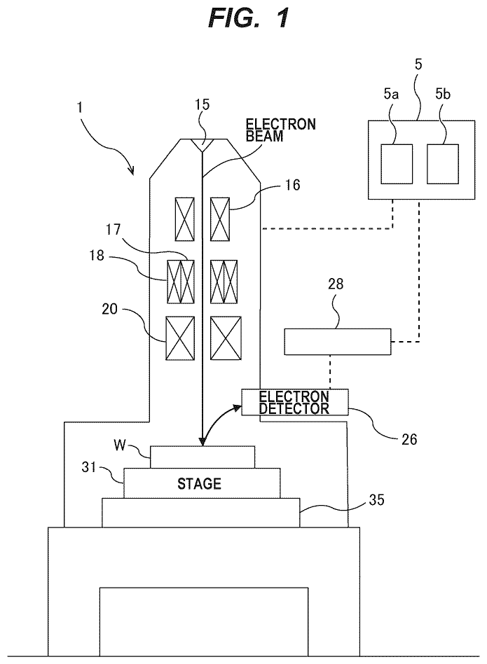

Hereinafter, embodiments of the present invention will be described with reference to the drawings. FIG. 1 is a schematic diagram showing an embodiment of an image generation system. The image generation system includes a scanning electron microscope 1 configured to generate an image of a workpiece W, and a processing system 5 configured to process the image generated by the scanning electron microscope 1. Examples of the workpiece W include wafer, mask, panel, and substrate that are objects for inspection and shape measurement of semiconductor devices.

The processing system 5 is composed of at least one computer. The processing system 5 includes a memory 5a storing programs therein, and an arithmetic device 5b configured to execute arithmetic operations according to instructions included in the programs. The memory 5a includes a main memory, such as a random access memory (RAM), and an auxiliary memory, such as a hard disk drive (HDD) or solid state drive (SSD). Examples of the arithmetic device 5b include a CPU (central processing unit) and a GPU (graphic processing unit). However, the specific configurations of the processing system 5 are not limited to these examples.

The processing system 5 may be an edge server coupled to the scanning electron microscope 1 by a communication line, or may be a cloud server coupled to the scanning electron microscope 1 by a communication network, such as the Internet or a local network, or may be a fog computing device (e.g., gateway, fog server, router, etc.) installed in a network coupled to the scanning electron microscope 1. The processing system 5 may be a combination of a plurality of servers. For example, the processing system 5 may be a combination of an edge server and a cloud server coupled to each other by a communication network, such as the Internet or a local network. In another example, the processing system 5 may include a plurality of servers (computers) that are not coupled by a network.

The scanning electron microscope 1 has an electron gun 15 configured to emit an electron beam, a converging lens 16 configured to converge the electron beam emitted from the electron gun 15, an X deflector 17 configured to deflect the electron beam in an X direction, a Y deflector 18 configured to deflect the electron beam in a Y direction, and an objective lens 20 configured to focus the electron beam on a workpiece W which is an example of a specimen, a workpiece stage 31 configured to support the workpiece W, and a stage-moving device 35 configured to translate the workpiece stage 31. A configuration of the electron gun 15 is not particularly limited. For example, a field-emitter type electron gun, a semiconductor-photocathode type electron gun, etc. can be used as the electron gun 15.

The electron beam emitted from the electron gun 15 is converged by the converging lens 16, and then deflected by the X deflector 17 and the Y deflector 18 while being focused by the objective lens 20 on a surface of the workpiece W. When the workpiece W is irradiated with primary electrons of the electron beam, electrons, such as secondary electrons and reflected electrons, are emitted from the workpiece W. The electrons emitted from the workpiece W are detected by an electron detector (scintillator) 26. Electron detection signals from the electron detector 26 are input to an image acquisition device 28 and converted into an image. In this manner, the scanning electron microscope 1 generates an image of the surface of the workpiece W. The image acquisition device 28 is coupled to the processing system 5.

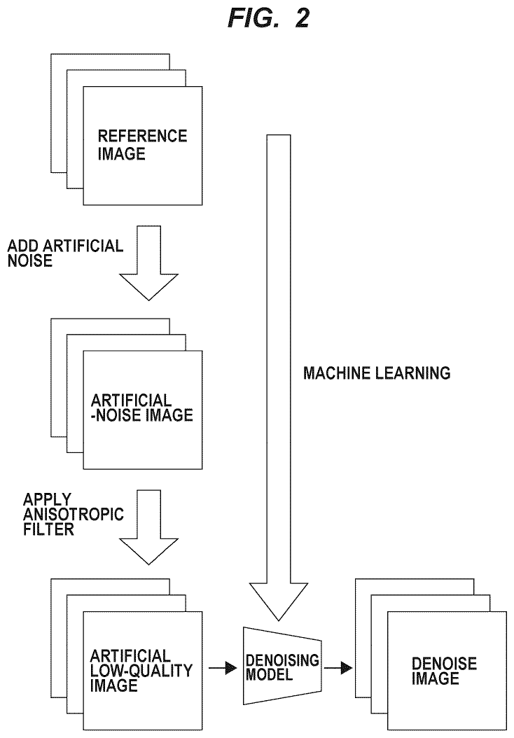

The processing system 5 has, in its memory 5a, a program for creating a denoising model that reduces noise from an image generated by the scanning electron microscope 1. Hereinafter, an embodiment of a method of creating the denoising model by machine learning will be described with reference to FIG. 2.

The processing system 5 instructs the scanning electron microscope 1 to generate a reference image of a sample. The sample may have the same structure as the workpiece W shown in FIG. 1, or may have a different structure. Examples of the sample include wafer, mask, panel, and substrate that are objects of inspection and shape measurement of semiconductor devices. The reference image is used as a ground-truth label or correct label for machine learning, and is a high-quality image. More specifically, the scanning electron microscope 1 can generate the reference image that is a high-quality image by scanning the surface of the sample with the electron beam at a low scanning rate.

The processing system 5 acquires the reference image from the scanning electron microscope 1. Furthermore, the processing system 5 adds artificial noise to the reference image to generate an artificial-noise image. The artificial noise is noise that is statistically independent between pixels of the reference image. In other words, the artificial noise has no correlation between pixels of the reference image. More specifically, the artificial noise follows a statistical distribution. Specific examples of the artificial noise include Poisson noise, Gaussian noise, and noise that follows a lognormal distribution.

In this embodiment, Poisson noise is used as the artificial noise because Poisson noise resembles the noise that appears on an image generated by the scanning electron microscope 1. Therefore, the denoising model constructed by the machine learning, which will be described later, is expected to be able to accurately reduce the noise on the image generated by the scanning electron microscope 1.

The processing system 5 generates an artificial low-quality image by applying an anisotropic filter to the artificial-noise image generated as described above. The anisotropic filter is configured to make the artificial noise on the artificial-noise image closer to real noise on an image generated by the scanning electron microscope 1. The real noise on the image is affected by the scanning operation of the electron beam, afterglow caused by the electron detector (scintillator) 26, and charging of an object to be imaged. The anisotropic filter is configured to imitate such noise that is characteristic of the scanning electron microscope 1.

The anisotropic filter is configured to stretch the artificial noise in the scanning direction of the electron beam of the scanning electron microscope 1. In one embodiment, the anisotropic filter is configured according to the following formula:

$$v ( x , y ) = {I}_{sampled} ( x , y ) * e \text{?} \qquad ( 1 )$$

$$\text{?} \text{indicates text missing or illegible when filed}$$

where, v(x, y) represents brightness value of a pixel at coordinates (x, y) after the anisotropic filter is applied, I_{sampled}(x, y) represents brightness value of the pixel at the coordinates (x, y), e represents Napier's number, τ represents attenuation constant, and symbol * represents convolution operation. The attenuation constant t has a theoretical value determined from scanning direction and scanning speed (or scanning rate) of the electron beam, material of the sample, and response characteristic of the electron detector (scintillator) 26, and can be obtained by calculation. In this embodiment, the scanning direction of the electron beam corresponds to the X direction.

In one embodiment, the anisotropic filter has parameters including at least the scanning rate and the scanning direction of the electron beam and the response characteristic of the electron detector 26. These parameters are set to coincide with the parameters that are used when the image to be denoised is generated.

In one embodiment, the anisotropic filter has parameters including at least material and cross-sectional structure of a surface of the sample, and acceleration voltage and current of the electron beam. These parameters are set to coincide with the parameters that are used when the image to be denoised is generated.

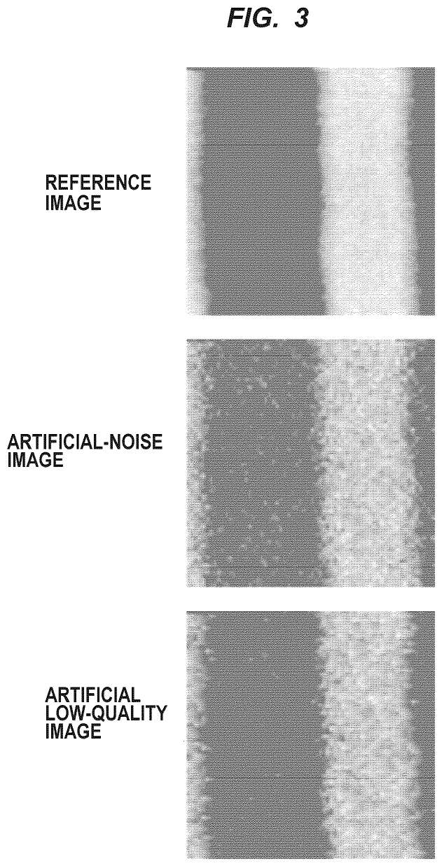

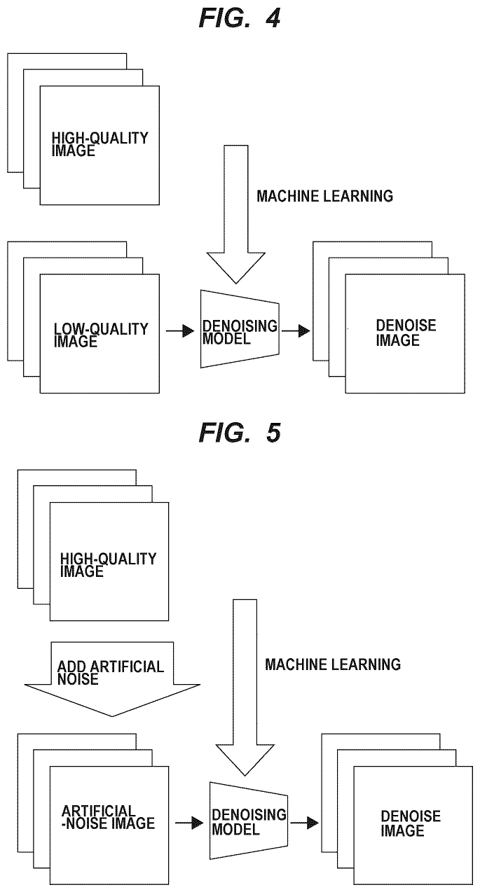

FIG. 3 is a diagram showing examples of the reference image, the artificial-noise image obtained by adding the artificial noise to the reference image, and the artificial low-quality image obtained by applying the anisotropic filter to the artificial-noise image. The artificial low-quality image is similar to a real low-quality image generated by the scanning electron microscope 1.

An anisotropy in a real image (SEM image) generated by the scanning electron microscope 1 can be caused by charging of the sample. In this case, instead of the above formula (1), a transfer function determined depending on the material of the sample surface, the cross-sectional structure of the sample, the accelerating voltage and the current of the electron beam, and the scanning rate of the electron beam may be used.

The artificial low-quality image generated by applying the anisotropic filter to the artificial-noise image and the reference image generated by the scanning electron microscope 1 are used as training data for the machine learning. Specifically, the artificial low-quality image is used as an explanatory variable, and the reference image is used as an objective variable (ground-truth label or correct label). The processing system 5 performs the machine learning to construct the denoising model that can minimize a difference between the reference image and an image output from the denoising model when the artificial low-quality image is input to the denoising model.

Examples of the machine learning include SVR (support vector regression) method, PLS (partial least squares) method, deep learning method, random forest method, and decision tree method. In one example, the denoising model is composed of a neural network constructed by the deep learning method.

The denoising model created by the machine learning using the training data including the reference image and the artificial low-quality image is stored as a trained model in the memory Sa of the processing system 5.

The denoising model created in this manner can accurately reduce noise in an image generated by the scanning electron microscope 1. Specifically, the scanning electron microscope 1 generates an image of the workpiece W that is to be subjected to inspection and shape measurement of a semiconductor device, and the processing system 5 acquires the image (SEM image) of the workpiece W from the scanning electron microscope 1, inputs the image of the workpiece W to the denoising model, and outputs a denoise image, which is an image with reduced noise, from the denoising model.

According to the embodiment, the anisotropic filter is configured to imitate noise that is characteristic of the scanning electron microscope 1. The anisotropic filter is applied to the artificial-noise image, so that the artificial low-quality image similar to an image containing real noise can be created. The machine learning is performed using the training data including such artificial low-quality images and reference images (high-quality images) to thereby generate the denoising model that can accurately reduce noise.

Now an example of applying the effect of the above denoising process to the measurement of semiconductor devices will be described. In this example, a semiconductor device has simple stripe patterns constituted by line patterns arranged side by side, and an edge roughness of each line is measured.

The scanning electron microscope 1 generates a plurality of SEM images with a scanning rate of 3 MHz. The processing system 5 applies the anisotropic filter expressed by the above formula (1) to these images, and creates a plurality of artificial low-quality images to which the artificial noise has been added. This artificial noise is equivalent to noise with a scanning rate of 100 MHz.

Next, the processing system 5 performs the machine learning using a pair of the SEM image (reference image) with the scanning rate of 3 MHz and the artificial low-quality image as the training data to generate an SEM image (reference image) from the artificial low-quality image, thereby creating the denoising model.

The processing system 5 uses the obtained denoising model to denoise an SEM image that has been actually generated at a scanning rate of 100 MHz. The edge roughness measured on an image under a high-image-quality condition of a scanning rate of 3 MHz was used as a reference. The correlation with the edge roughness measured from the denoised image was about 0.8. This is equivalent to the result measured under a scanning rate condition of 25 MHz, i.e., it was confirmed that an imaging speed can be increased by four times by using this denoising process.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to an image noise reduction method for reducing noise on an image generated by a scanning electron microscope.

### REFERENCE SIGNS LIST

1 scanning electron microscope
5 processing system
15 electron gun
16 converging lens
17 X deflector
18 Y deflector
20 objective lens
26 electron detector
28 image acquisition device
31 workpiece stage
35 stage moving device

1. An image noise reduction method of reducing noise from an image generated by a scanning electron microscope, comprising:
generating a reference image of a sample by the scanning electron microscope;
generating an artificial-noise image by adding artificial noise to the reference image;
generating an artificial low-quality image by applying an anisotropic filter to the artificial-noise image, the anisotropic filter being configured to stretch the artificial noise in a scanning direction of an electron beam of the scanning electron microscope;
creating a denoising model by performing machine learning using training data including the reference image and the artificial low-quality image;
generating an image of a workpiece by the scanning electron microscope, the workpiece being an object of inspection and shape measurement of a semiconductor device;
inputting the image of the workpiece into the denoising model; and
outputting a denoise image from the denoising model.

2. The image noise reduction method according to claim 1, wherein the anisotropic filter has parameters including at least a scanning rate and a scanning direction of the electron beam and a response characteristic of an electron detector of the scanning electron microscope, and the parameters are set to coincide with parameters that are used when the image of the workpiece is generated.

3. The image noise reduction method according to claim 1, wherein the anisotropic filter has parameters including at least material and cross-sectional structure of a surface of the sample, and acceleration voltage and current of the electron beam, and the parameters are set to coincide with parameters that are used when the image of the workpiece is generated.

4. The image noise reduction method according to claim 1, wherein the artificial noise follows a statistical distribution.

5. The image noise reduction method according to claim 4, wherein the artificial noise is Poisson noise.

6. The image noise reduction method according to claim 4, wherein the artificial noise follows a normal distribution or a lognormal distribution.
